(19) United States
(12) Patent Application Publication
(10) Pub. No.: US 2026/0305888 A1
(43) Pub. Date: Oct. 8, 2026

(54) Long-Handled Reusable In-Bowl Toilet Cleaning Tablet Cartridge for Sustained Cleaning

(71) Applicant: Ki Hyang Avis, Orange Park, FL (US)

(72) Inventor: Ki Hyang Avis, Orange Park, FL (US)

(73) Assignee: Ki Hyang Avis, Orange Park, FL (US)

(21) Appl. No.: 19/171,739

(22) Filed: Apr. 7, 2025

(51) Int. Cl. E03D 9/00; B08B 9/00

(52) U.S. Cl. CPC A47K 11/10; B08B 9/00; E03D 9/005

(57) ABSTRACT

A reusable toilet cleaning device is disclosed, comprising a cartridge having a manually orientable handle and a chamber configured to receive at least one cleaning tablet. The cartridge includes a wall with a plurality of apertures configured to control the exposure of the cleaning tablet to water, thereby regulating the release of cleaning solution when the device is submerged below a toilet bowl waterline. The device is configured for non-continuous, periodic placement to maintain hygiene through controlled chemical release during a predetermined cleaning period.

### DESCRIPTION OF RELATED ART

Traditional automatic toilet cleaning tablet methods, such as in-tank systems (e.g., Fluidmaster), offer consistent cleaning agent delivery but are prone to frequent and costly cartridge replacements. This results in increased consumer expenses and significant environmental waste. Furthermore, the use of chlorine tablets placed directly in the tank can lead to tank mechanism corrosion and potential leakage, compromising the integrity and lifespan of the toilet system.

In-bowl rim hangers, another popular cleaning solution, suffer from inconsistent cleaning results due to their placement above the waterline. This positioning hinders proper dissolution of the cleaning tablets and their distribution, ultimately leading to ineffective cleaning. Additionally, these rim hangers often become soiled, are visually unappealing, and detract from the aesthetic of the toilet.

There is a need for a toilet cleaning system that delivers sustained and effective cleaning while eliminating the drawbacks of frequent cartridge replacements, preventing potential leakage and corrosion associated with in-tank systems, and minimizing the visual impairment and hygiene issues associated with rim hangers. Such a system should also be user-friendly for placement and removal.

### BRIEF SUMMARY OF THE INVENTION

The present invention addresses the limitations of existing toilet cleaning solutions by providing a long handle reusable in-bowl toilet cleaning tablet cartridge designed for sustained cleaning. This cartridge uniquely combines ergonomic design with efficient cleaning agent delivery directly within the toilet bowl.

The cartridge features an elongated handle that facilitates ergonomic placement and retrieval from the toilet bowl, eliminating the need for the user to reach into the water. This handle is coupled with a contoured main body, specifically shaped to securely and stably fit within the lower portion of the toilet bowl, ensuring submersion below the waterline. The main body incorporates an accessible top opening that allows for the easy and convenient insertion of cleaning tablets, such as standard-sized chlorine-based tablets or other suitable cleaning agents.

A key feature of the invention is the permeable structure integrated within the main body. This structure, which may comprise perforations, a mesh, a basket weave, or other suitable configurations, facilitates efficient water circulation around and through the cleaning tablet(s). This promotes optimal dissolution of the cleaning agent(s), resulting in a concentrated cleaning solution being directly released within the toilet bowl. The direct release below the waterline allows the active cleaning agents to effectively permeate and coat the inner ceramic surface of the toilet bowl. This continuous cleaning action persists even after numerous flushing actions, promoting sustained cleanliness, reducing the accumulation of grime and stains, and significantly minimizing waste and the need for frequent replacements of the in-tank cartridge. The reusable nature of the cartridge further contributes to environmental sustainability.

### BRIEF DESCRIPTION OF THE DRAWINGS

FIG. 1 is a perspective view of the reusable toilet cleaning tablet cartridge according to an embodiment of the invention, showing the long handle (1), main body (2), top opening (3), and perforated or basket-like structure (4).

FIG. 2 illustrates the reusable toilet cleaning tablet cartridge as positioned within a toilet bowl below the waterline in its operational environment.

### DETAILED DESCRIPTION OF THE INVENTION

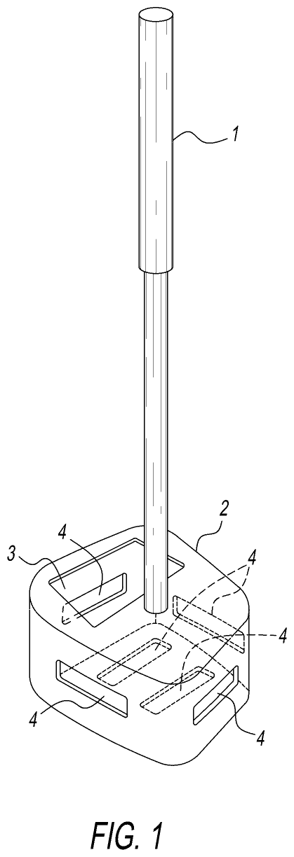

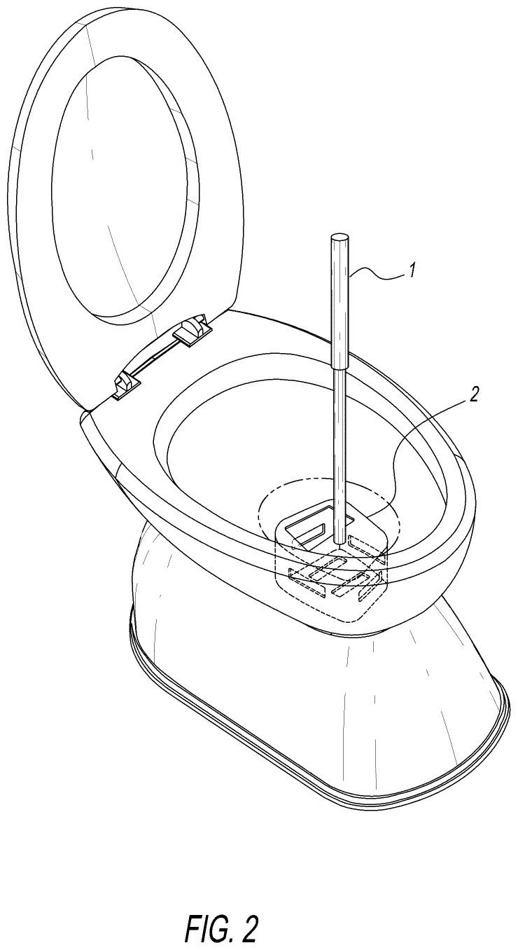

Referring to FIG. 1, the reusable toilet cleaning tablet cartridge comprises:
Long Handle (1):
   The long handle has a length ranging from 10 to 12 inches, which allows for easy placement and retrieval from the toilet bowl without requiring the user to reach into the water.
Main Body (2):
   The main body is constructed from durable and chemically inert materials such as high-density polyethylene (HDPE), PVC, or other materials commonly used for household cleaning products. The body is contoured to fit securely within the lower portion of the toilet bowl, ensuring proper placement below the waterline, as shown in FIG. 2. This design allows for a stable and reliable position during use.
Top Opening (3):
   The main body features a top opening (3) for easy insertion of cleaning tablets. The opening is sized to accommodate standard-sized chlorine or other commonly available cleaning tablets. The design of the opening allows users to conveniently add more tablets when necessary.
Perforated or Basket-Like Structure (4):
   Within the main body, the cartridge incorporates a perforated or basket-like structure (4). This design promotes water flow through the cartridge, facilitating the dissolution of cleaning tablets. The dissolved cleaning agents are then distributed throughout the toilet bowl, permeating the porous ceramic surface for effective and sustained cleaning action.

Referring to FIG. 2, the cartridge is placed in its operational position within a standard toilet bowl, below the waterline. In operation, a user inserts one or more cleaning tablets into the main body (2) through the top opening (3). The cartridge is then positioned within the lower part of the bowl, where its contoured shape ensures a secure fit. Water flows through the perforations or basket-like structure (4), dissolving the cleaning tablet(s) and the concentrated cleaning solution permeates the porous ceramic surface. This permeated solution continuously cleans the toilet bowl, even when the cartridge is no longer actively submerged in water, providing sustained hygiene and cleanliness.

1. (canceled)

2. (canceled)

3. (canceled)

4. (canceled)

5. A method for cleaning a toilet bowl using a handheld cleaning device, the handheld cleaning device comprising a handle affixed to a body defining a chamber configured to contain a cleaning tablet and having one or more water permeable openings, the method comprising:
(a) gripping the handle and manually placing the handheld cleaning device into standing water within a toilet bowl such that at least a portion of the body is submerged in the standing water;
(b) allowing the cleaning tablet within the chamber to dissolve through the one or more water permeable openings for a user-determined soaking duration to release a cleaning solution into the standing water within the toilet bowl;
(c) gripping the handle and manually retrieving the handheld cleaning device from the toilet bowl after the soaking duration; and
(d) removing the handheld cleaning device from the toilet bowl such that the handheld cleaning device is not present in the toilet bowl during normal toilet use.

6. The method of claim 5, wherein the handheld cleaning device is placed into the toilet bowl only when cleaning is desired by a user.

7. The method of claim 5, wherein the handheld cleaning device is removed from the toilet bowl prior to a subsequent use of the toilet.
